(19) United States
(12) Patent Application Publication
(10) Pub. No.: US 2026/0331318 A1
(43) Pub. Date: Oct. 22, 2026

(54) METHOD FOR MAINTAINING A NUCLEAR REACTOR

(71) Applicant: FRAMATOME, COURBEVOIE (FR)

(72) Inventors: Mickael LALLIER, CLAIRFAYTS (FR); Alexandre DUPUIS, SAINT SAULVE (FR); François Régis HUGUET, FONTAINES (FR); Eddy SZCZUREK, LE QUESNOY (FR)

(21) Appl. No.: 19/111,310

(22) PCT Filed: Sep. 14, 2023
(86) PCT No.: PCT/EP2023/075301

§ 371 Date: Mar. 13, 2025

(30) Foreign Application Priority Data
Sep. 15, 2022 (FR) FR 22 09303

(51) Int. Cl. G21C 19/20

(52) U.S. Cl. CPC G21C 19/207

(57) ABSTRACT

A maintenance method for a nuclear reactor relates to a drive assembly of a control rod assembly. The method includes the following steps: removing the initial weld of the omega seal and removing the jacket; carrying out at least one maintenance operation on the drive assembly; cutting an edge of the first lip of the omega seal; obtaining a replacement jacket including a new second lip; creating a new sealed weld between the first lip and the new second lip, the new weld being angularly offset by an angle of between 15° and 80° in relation to the initial weld.

The present disclosure relates to the maintenance of the control mechanisms of the control rod assemblies of a nuclear reactor.

### BACKGROUND

A nuclear reactor typically includes a pressure vessel wherein are arranged nuclear fuel assemblies forming together the core of the nuclear reactor. The reactivity of the core is controlled, among other things, by driving control rod assemblies into the core, each rod assembly comprising a plurality of rods made of a neutron-absorbing material.

Each control rod assembly is attached to the end of a drive rod, which is moved by a rod assembly drive mechanism (MCG in French for Mécanisme de Commande de Grappe).

The rod assembly drive mechanisms (MCGs) each serve to extract, maintain or insert a control rod assembly into the reactor core. Same must also permit the free fall of the rod assembly drive rods at the opening of the automatic shut-off circuit breakers of the reactor.

The nuclear reactor thereby comprises a plurality of control assemblies, each dedicated to a control rod assembly. Each drive assembly comprises an adapter rigidly attached to the lid of the pressure vessel, a housing for receiving a mechanism for lifting the drive rod of the control rod assembly and a jacket for receiving the drive rod. The housing, the lifting mechanism and the jacket form the MCG.

The adapter extends through the vessel lid and is rigidly attached thereto. Same defines a passage through which the drive rod moves.

The lifting mechanism is generally referred to as the lifting mechanism assembly (EML in French for Ensemble Mécanisme de Levée). The mechanism is an actuator the function of which is to control, insert or extract the drive rod of the control rod assemblies in the reactor core.

The housing and jacket together form a pressure enclosure in fluidic communication with the interior of the pressure vessel through the adapter.

The housing has a lower housing end typically screwed onto an upper end of the adapter. The sealing between the lower end of the housing and the upper end of the adapter is achieved by a welded seal, often referred to as a “Canopy” seal.

The jacket forms the upper end of the pressure enclosure. Same delimits an internal volume wherein the drive rod is housed in the high position of the control rod assembly. The internal volume is closed at the top and communicates with the internal volume of the casing at the bottom.

In order to create a sealed connection between the jacket and the housing, it is possible to provide a first lip at an upper end of the housing and a second lip at a lower end of the jacket. The first lip and the second lip are sealed to each other and form a seal known as the “Omega” seal.

As the EML is composed of moving parts that grip and move the drive rod, same is subject to wear phenomena that make it necessary to replace same after several million cycles.

In most cases, replacements are for rod assembly drive mechanisms (MCGs) that are reaching the limit of the service life thereof. Occasionally, MCGs can be replaced for malfunction reasons.

A solution for replacing a rod assembly drive mechanism (RMCG in French for Remplacement d'un Mécanisme de Commande de Grappe) on site is the replacement of the entire MCG by intervening at the “Canopy” seal. Such operation involves replacing the lifting mechanism assembly EML and the pressure enclosure (jacket+housing).

The RMCG “Canopy” solution may include the following operations:
Cutting the “Canopy” seal (located between the housing and the adapter of the lid),
Removing the entire MCG,
Machining the adapter to restore a weldable profile,
Refitting a new MCG (with a possible adjustment for pairing with the adapter),
Reconstitution of the welded “Canopy” seal,
Associated requalifications.

Another solution could be to intervene at the “Omega” seal by cutting along the axis of the original weld.

The RMCG solution “Omega” could include the following operations:
Cutting the “Omega” seal (located between the jacket and the housing of the MCG) along the axis of the weld in order to preserve the initial design of the welded seal (vertical cut),
Removing the jacket and the EML,
Machining the lip of the housing in order to restore a weldable profile, identical to the initial profile,
Refitting a new EML and a new jacket or the original jacket machined again on site,
Welding of the “Omega” seal identical to the initial design,
Associated re-qualifications.

Such solutions are not entirely satisfactory.

The RMCG “Canopy” solution requires:
The replacement of the complete MCG including the pressure enclosure (jacket+housing),
Removing/refitting the heat insulation of the lid, which has an impact on the schedule of the operation.

The RMCG “Omega”, with vertical cutting of the welded seal, is also not satisfactory on the following points.

EML replacement tests were carried out by intervening at the “Omega” seal.

After cutting along the axis of the weld of the “Omega” seal (vertical cut), a dye penetrant inspection was carried out to make sure the surface finish had no defect. Out of an assembly of more than 50 cut MCGs, 38% of the dye penetrant inspections show non-conforming surface defects in the thin lips.

The random and unpredictable presence of the defects does not make it possible to prepare a site with sufficiently control. The defects require systematic repair and justification. In most cases, same may not even prove repairable or would be repairable at the cost of developing complex methods.

As an emergency, intervention at the “Canopy” seal would then be necessary.

### SUMMARY

In such context, the present disclosure provides a method of maintaining a nuclear reactor that makes it possible to reliably and economically maintain a rod assembly drive assembly.

To this end, the present disclosure provides a method of maintaining a nuclear reactor, the nuclear reactor comprising at least one drive assembly for a control rod assembly, the or each drive assembly comprising an adapter rigidly attached to a lid of a pressure vessel of the nuclear reactor, a housing for receiving a mechanism for lifting a drive rod of the control rod assembly and a jacket for receiving the drive rod, the housing having an housing lower end linked in a leak-tight manner to the adapter, the housing having a first lip at an housing upper end, the jacket having a second lip at a jacket lower end, the first lip and the second lip being welded to each other by an initial weld and forming together an omega seal, the omega seal having an initial shape obtained by the rotation of an initial arcuate line about an axis of rotation, said initial arcuate line having an initial geometric center, a first initial arc belonging to the first lip, and a second initial arc belonging to the second lip and linked to the first initial arc by an initial welding point, the initial welding point defining with the initial geometric center a line extending along a reference direction, the maintenance comprising the following steps:
removing the initial weld and removing the jacket;
carrying out at least one maintenance operation on the drive assembly;
cutting an edge of the first lip;
obtaining a replacement jacket with a new second lip;
creation of a new sealed weld between the first lip and the new second lip, the first lip and the new second lip together defining a new omega seal, the new omega seal having a shape obtained by rotating a new arcuate line about said axis of rotation, said new arcuate line having a new geometric center, a new first arc belonging to the first lip, and a new second arc belonging to the new second lip and connected to the new first arc by a new welding point, the new welding point defining together with the geometric center a line extending along a new direction angularly shifted by an angle comprised between 15° and 80° with respect to the reference direction.

Thereby, the operation is carried out at the “Omega” seal. As a result, the housing remains in place and is not replaced unnecessarily. Only the EML and, if appropriate, the jacket are replaced.

It is not necessary to remove the heat-insulation of the lid. Thereof generates a dosimetric gain.

A saving in terms of schedule results therefrom, compared to the RMCG “Canopy” solution.

Moreover, the inherent risk of defect in the RMCG “Omega” described hereinabove is much more limited.

The sealed welded connection between the housing and the jacket is recreated between a new second lip and a surface of the first lip obtained by removing the edge of the first lip. The surface is free of defects, the defects having been removed by cutting the edge of the original first lip.

Such particular surface is not a zone thermally affected by the creation of the original welded seal, since the edge of the original first lip has been removed.

The maintenance method can further have one or a plurality of the following features, considered individually or in all technically possible combinations:
the replacement jacket is the initial jacket, the new second lip having been created on said initial jacket;
the replacement jacket is a new jacket;
the method comprises, between the step of removing the initial weld and the cutting step, a step of checking the surface state of the first lip in order to detect any defect, a width of the edge of the first lip cut at the cutting step being chosen so as to remove the defect, if any;
the rod moves along an axis of movement, the direction of reference direction parallel to the axis of movement;
the step of removing the initial weld, said initial weld is cut along the reference direction or along a direction forming an angle of less than 15° with the reference direction;
the new second arc is longer than the initial second arc;
the new omega seal has the same shape as the original omega seal;
the new sealed weld is angularly offset from the initial weld toward the first lip.

### BRIEF SUMMARY OF THE DRAWINGS

Other features and advantages of the present disclosure will be clear from the description thereof which is given below as an example, but in no way limited to, with reference to the enclosed Figures, among which:

FIG. 1 is a simplified schematic representation of a nuclear reactor;

FIG. 2 is a section view of a rod assembly drive mechanism of the nuclear reactor shown in FIG. 1;

FIG. 3 is an enlarged view of the “Canopy” seal of the welded connection between the housing and the adapter on which the rod assembly drive mechanism shown in FIG. 2 is mounted;

FIG. 4 is an enlarged view of the “Omega” seal of the welded connection between the housing and the jacket of the rod assembly control mechanism shown in FIG. 2, prior to the implementation of the maintenance method of the present disclosure; and

FIG. 5 is a view similar to the view shown in FIG. 4, after the implementation of the method of the present disclosure.

### DETAILED DESCRIPTION

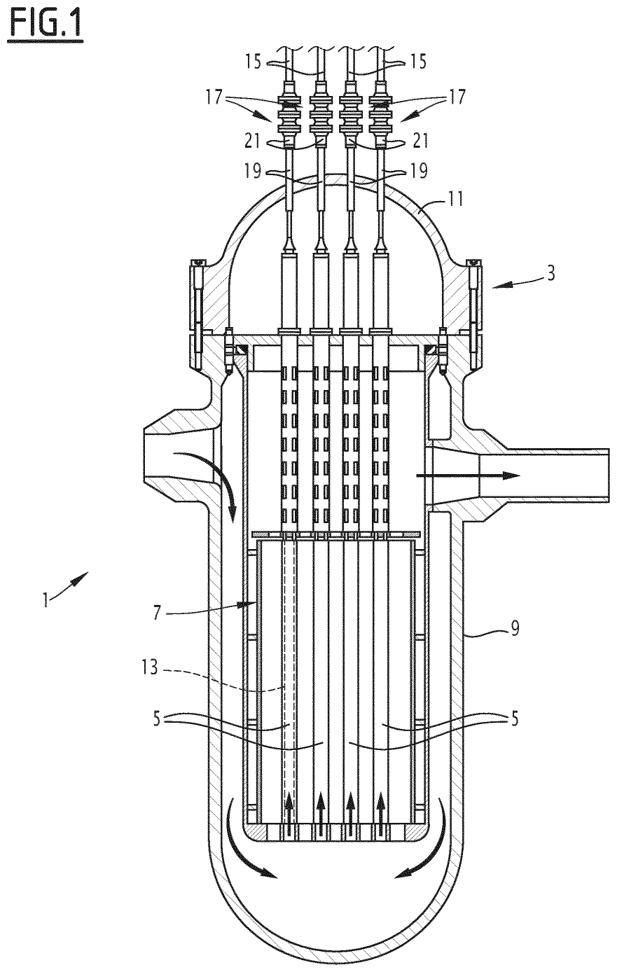

The nuclear reactor 1 shown in FIG. 1 includes a pressure vessel 3 wherein nuclear fuel assemblies 5 are arranged forming the core 7 of the nuclear reactor.

The pressure vessel 3 includes a lower part 9 and a lid 11 attached in a removable manner to the lower part 9.

The nuclear reactor 1 further includes control rod assemblies 13 which can be inserted or extracted from the core 7 in order to control the reactivity of the core.

Each rod assembly 13 comprises a plurality of rods made of a neutron-absorbing material.

Each control rod assembly 13 is attached to the end of a drive rod 15, as such moved by a rod assembly drive mechanism (MCG).

The rod assembly drive mechanisms (MCGs) each serve to extract, maintain or insert a control rod assembly into the reactor core. Same must also permit the free fall of the rod assembly drive rods at the opening of the automatic shut-off circuit breakers of the reactor.

The nuclear reactor 1 thereby comprises a plurality of control assemblies 17, each dedicated to a control rod assembly 13.

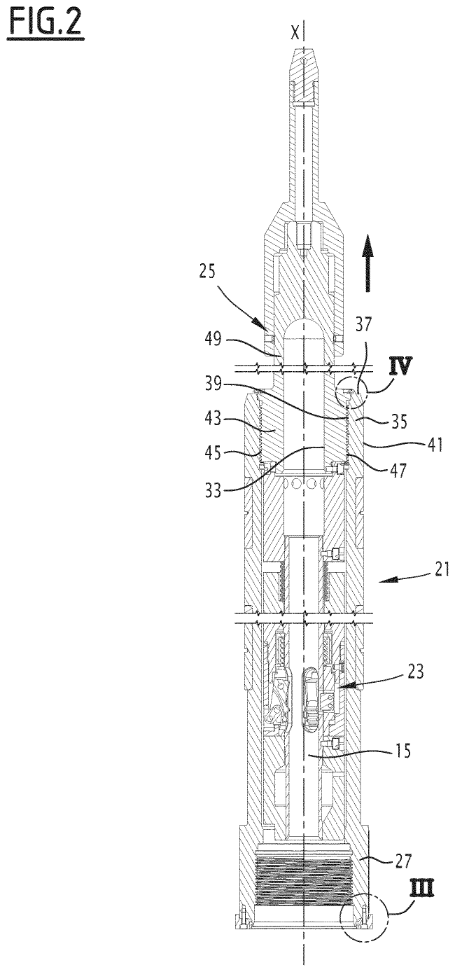

Each drive assembly 17 comprises an adapter 19 rigidly attached to the lid 11 of the pressure vessel, a housing 21 for receiving a mechanism 23 for lifting the drive rod 15 of the control rod assembly 13 and a jacket 25 for receiving the drive rod 15 (FIGS. 1 and 2). In FIG. 1, the jackets are not shown so as to make visible the upper ends of the drive rods 15.

The adapter 19 is engaged in a through orifice of the lid 11 of the vessel and is rigidly attached thereto. Same extends through the lid 11 of the vessel and delimits a passage through which the drive rod 15 moves.

The lifting mechanism 23 is generally referred called the lifting mechanism assembly (EML). Such mechanism is an actuator the function of which is to control, insert or extract the drive rod 15.

The housing 21 and the jacket 25 together form a pressure enclosure, in fluidic communication with the inside of the pressure vessel through the adapter 19.

The lifting mechanism 23, the housing 21 and the jacket 25 form the sub-assembly generally referred to by the term rod assembly drive mechanism (MCG for Mécanisme de Commande de Grappe).

The housing 21 is a tubular part, having a central axis corresponding substantially to the axis of movement X of the drive rod 15. Same internally delimits an internal volume wherein the drive rod 15 is engaged. The lifting mechanism 23 is housed between the rod and the wall of the housing.

In the present description, the terms lower and upper, the bottom and the top, are understood along the axis of movement X of the drive rod 15.

The axis is normally vertical.

Housing 21 has an housing lower end 27 connected in a leak-tight manner to the adapter 19.

More precisely, the housing lower end 27 is typically screwed onto an upper end 29 of the adapter 19.

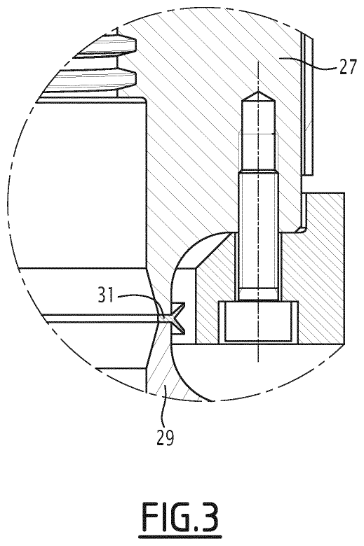

The seal between the housing lower end 27 and the upper end 29 of the adapter is provided by a welded seal 31, frequently called a “Canopy” seal (FIG. 3).

The jacket 25 forms the upper part of the pressure vessel.

Same delimits an internal volume 33 wherein the drive rod 15 is housed in the high position of the control rod assembly 13. The internal volume 33 is closed upwards and communicates with the internal volume of the housing 21 downwards.

The housing 21 has an housing upper end 35 with a tubular shape about the axis of movement X.

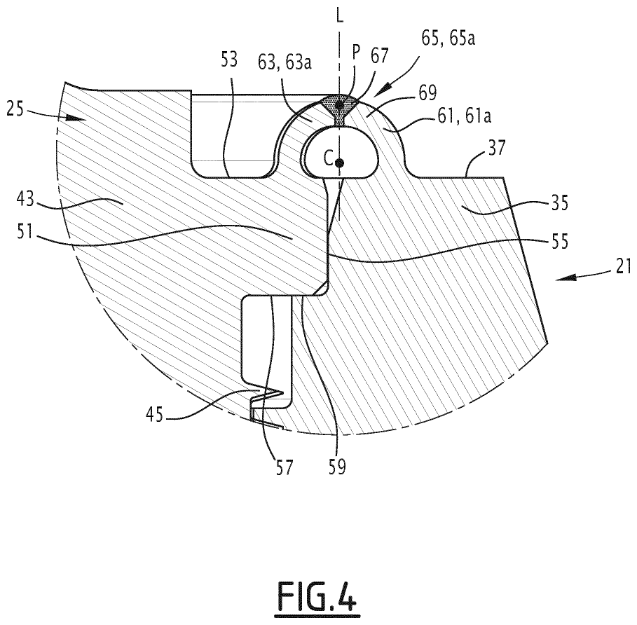

As can be seen in FIGS. 2 and 4, the housing upper end 35 has a substantially annular housing upper surface 37 perpendicular to said axis of movement X and turned away from the adapter 19.

The housing upper end 35 also has a housing radially inner surface 39 and a housing radially outer surface 41;

The jacket 25 has a jacket lower end 43 engaged in the housing upper end 35 and fastened thereto.

To this end, the jacket lower end 43 has an external thread 45 cooperating with a tapping 47 supported by the housing radially inner surface 39.

The jacket 25 further has a main part 49 situated outside the housing 21.

An annular rib 51 is provided on the jacket lower end 43 at the junction with the main part 49. Same is located above the exterior thread 45.

The jacket lower end 43 has a substantially annular jacket upper surface 53 perpendicular to the axis of movement X and turned opposite the adapter 19.

The jacket upper surface 53 is defined by the annular rib 51.

The jacket upper surface 53 extends substantially in the same plane as the housing upper surface 37.

The jacket lower end 43 also has a radially outer surface 55.

This radially outer surface 55 is defined by the annular rib 51.

Same bears against the housing radially inner surface 39.

The annular rib 51 further defines a jacket lower surface 57 that is substantially annular and perpendicular to the axis of movement X. The jacket lower surface 57 bears on a shoulder 59 formed in the radially inner surface 39 of the housing upper end 35.

As illustrated in FIG. 4, before the method of the present disclosure is implemented, the housing 21 has a first lip 61 at the housing upper end 35.

The jacket 25 has a second lip 63 at the jacket lower end 43.

The first lip 61 and the second lip 63 are welded to each other in a sealed manner by an initial weld 67.

Together same form an omega seal 65.

The housing upper surface 37 supports the first lip 61.

The jacket upper surface 53 supports the second lip 63.

The omega seal 65 has an initial shape obtained by rotating an initial arcuate line 65a about an axis of rotation.

The axis of rotation corresponds substantially to the axis X of movement of the drive rod.

An initial arcuate line 65a is shown in FIG. 4. Same corresponds substantially to the section of the omega seal 65 in a radial plane containing the axis of rotation X.

The initial arcuate line 65a has a certain thickness, corresponding to the thickness of the omega seal 65.

The initial arcuate line 65a has an initial geometric center C.

The initial geometric center C, when the initial arcuate line 65a is an arc of a circle, corresponds to the center of the arc of a circle.

When the initial arcuate line 65a is not an arc of a circle, the initial geometric center C is e.g. the isobarycenter of all the points of the initial arcuate line. In a variant, the geometric center C is the isobarycenter of all the points of the inner surface with initial arcuate line 65a, or else the isobarycenter of all the points of the outer surface with initial arcuate line 65a.

The initial arcuate line 65a has a first initial arc 61a belonging to the first lip 61, and a second initial arc 63a belonging to the second lip 63 and connected to the first initial arc 61a by an initial welding point P.

The initial welding point P belongs to the initial welding 67.

The initial welding 67 has a shape obtained by the rotation of the initial welding point P about the axis of rotation X.

The initial welding point P defines with the initial geometric center C, a line L extending along a reference direction.

As can be seen in FIG. 4, the initial welding point P has a certain surface area.

To define the line L, e.g. the isobarycenter of all the points forming part of said surface is considered.

Typically, the reference direction is parallel to the axis of movement X of the rod.

The first and second lips 61, 63 each extend all around the axis X and have closed contours. Same are curved toward each other.

The first and second initial arcs 61a, 63a typically each have the shape of a quarter of a circle. The initial arcuate line 65a is a semicircle centered on the point C.

Thereby, the initial shape of the omega seal 65 corresponds to a half torus, coaxial with the axis X.

The first and second lips 61, 63 delimit with the housing upper surface 37 and with the jacket upper surface 53 a cavity extending all around the axis X.

The seal 65 is called omega-shaped because of the shape thereof.

The purpose of the maintenance method is to work on the drive assembly 17 in order to perform a maintenance operation on same.

The maintenance method comprises the following steps:
removing the initial weld the 67 and removing the jacket (25);
carrying out at least one maintenance operation on the drive assembly 17;
cutting an edge 69 of the first lip 61;
obtaining a replacement jacket 25R including a new second lip 71;
creation of a new sealed weld 73 between the first lip 61 and the new second lip 71, the first lip 61 and the new second lip 71 together defining a new omega seal 73.

During the step of removing the initial weld 67, said initial weld 67 is cut along the reference direction L or along a direction forming an angle of less than 15° with the reference direction L.

The removal is typically carried out by remote operation, by any suitable means (grinding wheel, saw, machining machine, etc.).

After the discharge of the jacket 25, it is possible to access the EML 23.

At least one maintenance operation typically includes one or a plurality of the following operations:
replacement or repair of the jacket 25,
replacement or repair of the EML 23,
repair of the housing upper end 35.

The method preferably comprises, between the step of removing the initial weld 67 and the cutting step, a step of checking the surface state of the first lip 61 for detecting a possible defect.

Such defect is typically the presence of cracks or cavities, which can lead to a non-conformity of the new sealed weld 73.

The check shall be carried out by dye penetrant inspection, radiography or any other suitable method.

The edge 69 is the edge of the first lip initially welded to the second lip by the welding 67. Same is cut over the entire periphery of the first lip 61. It is thereby possible to remove the part of the initial weld remaining attached to the first lip 61 at the end of the removal step. It is thereby possible to create a new surface, having a good surface state, for the purpose of welding the first lip 61 to the new second lip 71.

The edge 69 of the first lip is cut over a width chosen so as to eliminate any defect detected during the inspection step.

The cut-out width herein corresponds to the dimension taken in a radial plane, around the axis of rotation.

In a variant, the inspection step is not carried out, and the edge of the first lip is cut to a predetermined width.

The cutting is typically carried out by remote operation, by any suitable means (laser, saw, machining machine, etc.).

The replacement jacket 25R is e.g. the initial jacket 25, the new second lip 71 having been created on said initial jacket 25.

The new second lip 71 is created by any suitable means: welding of an extension to the initial second lip 63, removal of the initial second lip 63 and fastening of a new second lip 71 instead of the initial second lip, etc.

In a variant, the replacement jacket 25R is a new jacket, which has never been used in a nuclear reactor. Same is manufactured directly with the new second lip 71, having the required dimensions.

According to another variant, the replacement jacket 25R is a reused jacket, but coming from another drive assembly 17, from the same nuclear reactor or from another nuclear reactor. The jacket is then modified so as to include a new second lip having the required dimensions.

The new welding is typically carried out by remote operation or manually. The welding process is the same as for the initial welding. Typically, the welding method is a TIG/GTAW welding.

The new omega seal 75 has a shape obtained by the rotation of a new arcuate line 75b about the axis of rotation X.

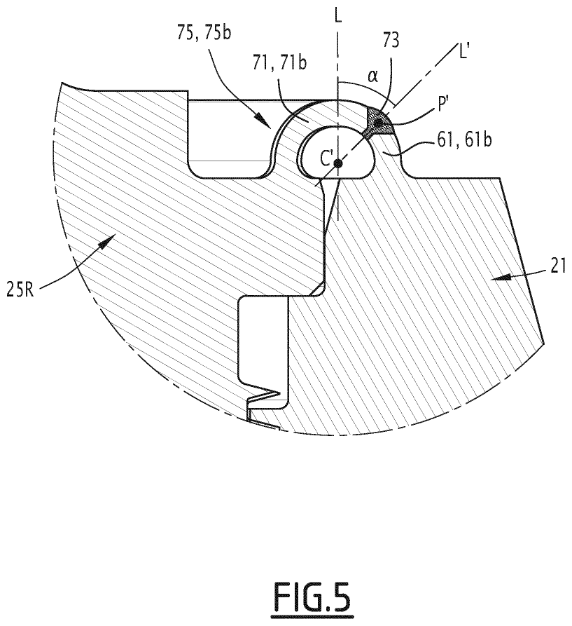

The new arcuate line 75b is represented in FIG. 5. Same corresponds substantially to the section of the new omega seal 75 in a radial plane containing the axis of rotation X.

The new arcuate line 75b has a certain thickness, corresponding to the thickness of the new omega seal 75.

The new arcuate line 75b has a new geometric center C′.

The new geometric center C′ is defined as the initial geometric center C.

The new arcuate line 75b has a new first arc 61b belonging to the first lip 61, and a new second arc 71b belonging to the new second lip 71 and connected to the new first arc 61b by a new welding point P′.

The new spot weld P′ belongs to the new weld 73.

The new weld 73 has a shape obtained by the rotation of the new weld P′ about the axis of rotation X.

The new welding point P′ is defined as the initial welding point P.

The new welding point P′ defines together with the new geometric center C′, a line extending along a new direction L′ angularly offset by an angle α comprised between 15° and 80° with respect to the reference direction L.

The offset results from the fact that the edge 69 of the first lip 61 has been cut.

The angle α is preferably comprised between 25° and 70°, else preferably between 30° and 60°.

The new second arc 71b is longer than the second initial arc 63a.

The new first arc 61b is shorter than the first initial arc 61a.

As a result, the new weld 73 is angularly offset relative to the initial weld 67 toward the first lip 61, i.e. is angularly offset from the side of the first lip.

On the other hand, the new omega seal 75 preferably has substantially the same shape as the initial omega seal 65.

In particular, the new geometric center C′ is substantially at the same position as the initial geometric center C.

What is claimed is:

1-9. (canceled)

10: A method of maintaining a nuclear reactor, the nuclear reactor comprising at least one drive assembly for a control rod assembly, the or each drive assembly comprising an adapter rigidly attached to a lid of a pressure vessel of the nuclear reactor, a housing for receiving a mechanism for lifting a drive rod of the control rod assembly and an initial jacket for receiving the drive rod, the housing having an housing lower end linked in a leak-tight manner to the adapter, the housing having a first lip at an housing upper end, the initial jacket having a second lip at a jacket lower end, the first lip and the second lip being welded to each other by an initial weld and forming together an original omega seal, the original omega seal having an initial shape obtained by a rotation of an initial arcuate line about an axis of rotation, said initial arcuate line having an initial geometric center, a first initial arc belonging to the first lip, and a second initial arc belonging to the second lip and linked to the first initial arc by an initial welding point, the initial welding point defining with the initial geometric center, a line extending along a reference direction, the method comprising the following steps:
removing the initial weld and removing the initial jacket;
carrying out at least one maintenance operation on the drive assembly;
cutting an edge of the first lip;
obtaining a replacement jacket including a new second lip; and
creation of a new sealed weld between the first lip and the new second lip, the first lip and the new second lip together defining a new omega seal, the new omega seal having a shape obtained by rotating a new arcuate line about said axis of rotation, said new arcuate line having a new geometric center, a new first arc belonging to the first lip, and a new second arc belonging to the new second lip and connected to the new first arc by a new welding point, the new welding point defining together with the new geometric center a line extending along a new direction angularly shifted by an angle comprised between 15° and 80° with respect to the reference direction.

11: The method of claim 10, wherein the replacement jacket is the initial jacket, the new second lip having been created on said initial jacket.

12: The method according to claim 10, wherein the replacement jacket is a new jacket.

13: The method according to claim 10, wherein the method comprises, between the step of removing the initial weld and the cutting step, a step of monitoring a surface condition of the first lip in order to detect a defect, a width of the edge of the first lip cut at the cutting step being selected so as to eliminate the defect.

14: The method according to claim 10, wherein the rod moves along an axis of movement, the reference direction being parallel to the axis of movement.

15: The method according to claim 10, wherein in the step of removing the initial weld, said initial weld is cut along the reference direction or along a direction forming an angle of less than 15° with the reference direction.

16: The method according to claim 10, wherein the new second arc is longer than the initial second arc.

17: The method according to claim 10, wherein the new omega seal has a same shape as the original omega seal.

18: The method according to claim 10, wherein the new omega seal is angularly offset from the original omega seal toward the first lip.
